(19) United States
(12) Patent Application Publication
(10) Pub. No.: US 2003/0128970 A1
(43) Pub. Date: Jul. 10, 2003

(54) System and method for providing high definition material on a standard definition compatible medium

(75) Inventors: Tse-Hua Lan, Ossining, NY (US); Lilla Boroczky, Mount Kisko, NY (US)

Correspondence Address: PHILIPS ELECTRONICS NORTH AMERICAN CORP, 580 WHITE PLAINS RD, TARRYTOWN, NY, 10591, US

(73) Assignee: Koninklijke Philips Electronics N.V.

(21) Appl. No.: 10/043,743

(22) Filed: Jan. 10, 2002

(51) Int. Cl. H04N 5/92; H04N 5/781

(52) U.S. Cl. 386/112; 386/123; 386/125

(57) ABSTRACT

A system and method for recording and reconstructing a high definition video on a standard definition DVD. A recording system is provided that comprises: a system for scaling down an HD video to an SD video format; a system for encoding the SD video; a system for extracting enhancement information from the HD video; and a system for storing the SD video and the extracted enhancement information onto the SD compatible medium. A playback system is provided for reconstructing the HD video image from the standard definition SD format recording, comprising: a system for extracting and decoding SD data from the recording; a system for extracting enhancement information from the recording; a system for de-interlacing the decoded SD data; and a system for up-scaling and post-processing the decoded SD data with the enhancement information to generate the HD video image.

### BACKGROUND OF THE INVENTION

1. Technical Field

The present invention relates generally to systems for recording and playing back digital image data, and more particularly relates to a system and method for recording high definition material on a standard definition compatible DVD so that the DVD can be played back in either a standard or high definition mode.

2. Related Art

As DVD (digital versatile disk) players become the medium of choice for video playback, and eventually video recording, the demand for DVD systems having advanced features is expected to grow. For instance, various companies, including Philips Electronics, have recently launched DVD recorders into the marketplace. As DVD recorders become more popular in the future, recording TV programs and the like on DVDs will become easier and more affordable.

One of the issues, however, that has yet to be adequately addressed relates to the increasing popularity of high definition (HD) material. Presently, there is no set format for using standard definition (SD), i.e., 4.7 GB, single sided, DVDs for recording and playing back high definition (HD) material (referred to herein as HD-on-SD-DVD). This issue will only become more important as 2006 approaches, which is when the Advanced Television Systems Committee (ATSC) has mandated that high definition broadcasts become the standard for U.S. television channels.

Based on the above, it can be seen that recording HD video in a standard, i.e., SDDVD format, will become an important option for DVD recorders and open new markets for consumer electronics, semiconductors and film industries. Furthermore, techniques for providing HD-on-SD-DVD will become useful for other applications and mediums that support long play mode recording, such as HD-DVD recorders or hard-disk based recorders.

Accordingly, a need exists for a system that can provide HD material on a SD compatible medium, such as an SD-DVD.

### SUMMARY OF THE INVENTION

The present invention addresses the above-mentioned issues, as well as others, by providing a system and method for providing HD recording and playback systems that provide an HD feel on an up-converted SD image using enhancement information extracted from the original HD image during recording.

In a first aspect, the invention provides a recording system for recording a high definition video onto a standard definition compatible medium, comprising: a system for scaling down the HD video to an SD video format; a system for encoding the SD video; a system for extracting enhancement information from the HD video; and a system for storing the SD video and the extracted enhancement information onto the SD compatible medium.

In a second aspect, the invention provides a playback system for reconstructing a high definition video image from a standard definition format recording, comprising: a system for extracting and decoding SD data from the recording; a system for extracting enhancement information from the recording; a system for de-interlacing the decoded SD data; and a system for up-scaling and post-processing the decoded SD data with the enhancement information to generate the HD video image.

In a third aspect, the invention provides a method for recording high definition (HD) video onto a standard definition compatible medium, comprising: scaling down the HD video to an SD video format; encoding the SD video; generating enhancement information from the HD video; and storing the SD video and the enhancement information onto the SD compatible medium.

In a fourth aspect, the invention provides a method of reconstructing a high definition video image from a standard definition format recording, comprising: extracting and decoding SD data from the recording; extracting enhancement information from the recording; de-interlacing the decoded SD data; and up-scaling and post-processing the decoded SD data with the enhancement information to generate the HD video image.

In a fifth aspect, the invention provides a program product stored on a recordable medium for recording high definition video onto a standard definition DVD, comprising: means for scaling down the HD video to an SD format video; means for encoding the SD video; means for generating enhancement information from the HD video, wherein the enhancement data comprises high frequency image data; and means for storing the SD format video and the enhancement information onto the DVD.

In a sixth aspect, the invention provides a program product stored on a recordable medium for reconstructing a high definition video image from a standard definition DVD, comprising: means for extracting and decoding SD data from the DVD; means for extracting enhancement information from the DVD, wherein the enhancement information is stored in an MPEG userdata field and comprises high frequency image data; means for de-interlacing the decoded SD data; and means for up-scaling and post-processing the decoded SD data with the enhancement information to generate the HD video image.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a recording system in accordance with the present invention.

FIG. 2 depicts a playback system in accordance with the present invention.

### DETAILED DESCRIPTION OF THE INVENTION

1. Overview

The present invention provides a video processing system and method that can record HD material in an SD compatible DVD (SD-DVD) in a manner such that the DVD can be played back in a regular DVD player for regular SD viewing, or in an HD enabled DVD player for HD viewing. Any type of writable or re-writable DVD (e.g., DVD-R, -RW, +RW, -RAM) may be utilized. Using the techniques described herein, the system is able to record a two-hour “near” HD quality video in a 4.7 GByte DVD, or a four-hour near HD video in a 9 Gbyte DVD. As will be explained in further detail below, during recording, the system both: (1) converts the inputted HD signal into an SD signal; and (2) generates enhancement information from the HD signal. The system then encodes the SD signal, e.g., using an MPEG-2 encoder, and stores the enhancement information, e.g., in the userdata field of the MPEG bitstream.

The exemplary embodiments described herein utilize only a relatively small amount of enhancement information that captures important HD image features, such as edge and texture information. In this manner, a low bitrate can be used for the enhancement information (i.e., less than 0.5 Megabytes/second) and the combination of the SD signal and enhancement information can be maintained at approximately 5 Megabytes/second. Prior art approaches, such as MPEG-2 layered or scalable coding, could not maintain such a low bitrate at a reasonable quality.

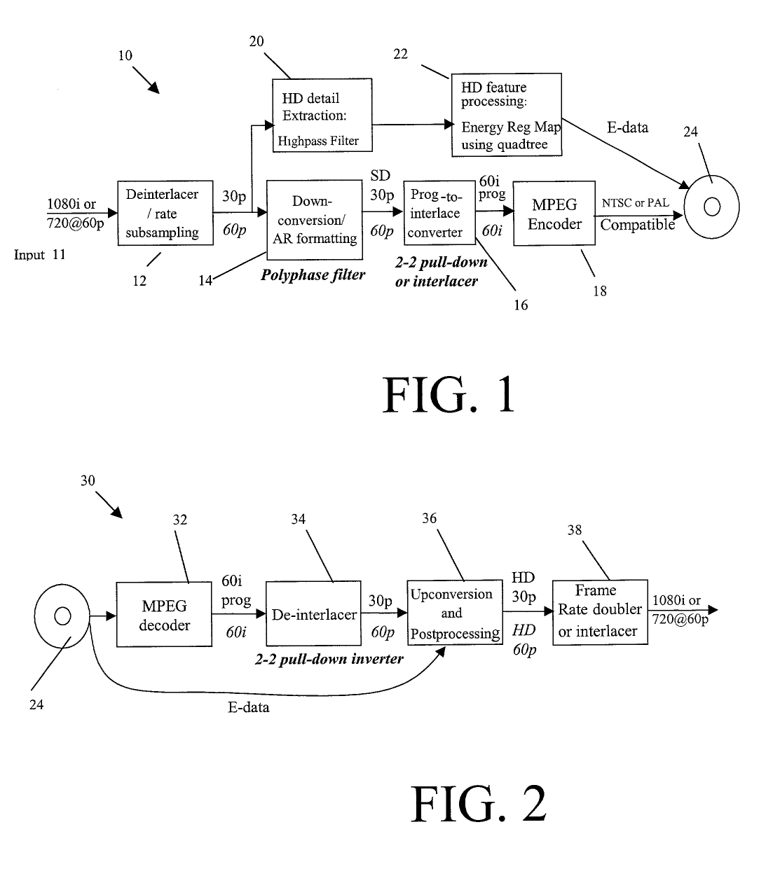

During playback, the recorded DVD is not only fully compatible to current DVD standards, but the DVD can also be played back in an HD enabled DVD player that uses the enhancement data to generate an HD quality video. Note that while the embodiments provided herein in FIGS. 1 and 2 describe the SD format output 24 as a DVD, it should be understood that any recordable medium could be utilized.

2. Recording System

Referring now to FIG. 1, an exemplary recording system 10 in accordance with the present invention is shown. System 10 receives an HD input signal 11 and generates an SD format output 24. The input of the system may accept all ATSC formats either in bitstream form or in component-signal form (for the bitstream form, an HD MPEG-2 decoder would be required). However, for the purpose of explanation, system 10 is shown accepting 1080 i (interlaced) and 720 p (progressive) formats. Accordingly, the exemplary system is capable of processing two different formats, progressive and interlaced, both of which are compatible with current SD standards. The progressive format is noted as 30 p or 60 i prog(ressive) (similar to film mode), and they are in the upper part of flow arrows after the “prog-to-interlace-converter” block 16. Note that 60 i prog is structurally the same as 30 p, except that 60 i prog is treated as the interlaced format. The reason for converting 30 p to the 60 i progressive format is to guarantee the compatibility of the recorded DVD for all the DVD players that support (re)writable DVDs. The interlaced format is noted as 60 i, and it is in the lower part of the flow arrows.

The basic operation of the recording system 10 is as follows. The input pictures (i.e., video) are scaled down to SD pictures, and some important HD features or HD enhancement data (referred to herein as E-data) is extracted from the input. An MPEG-2 encoder then codes the SD sequences, and the MPEG-2 bitstream is saved in storage (e.g., DVD+RW) together with E-data. The E-data can be stored in the userdata field of the MPEG bitstream.

System 10 comprises a de-interlacer/rate subsampling system 12 that deinterlaces or subsamples the input signal 11 to 30 p or 60 p formats. Down-conversion/aspect ratio (AR) formatting system 14 then formats the signal with a widescreen, letterboxing, or expansion (pan and scan) aspect ratio format. Progressive-to-interlace converter 16 performs a 2-2 pull-down from 30 p to 60 i prog, or performs interlacing to convert 60 p to 60 i. MPEG encoder 18 then encodes the signal into an NTSC or PAL compatible format.

In addition, after the input signal is de-interlaced/subsampled, the signal is also passed to an HD detail extraction system 20, which extracts high frequency image data from the signal. The extraction may be accomplished with, for instance, a high pass filter or residual operator. The high frequency image data is then passed to an HD feature processing system 22 to generate HD enhancement information, or E-data. The E-data is then stored with the SD format output 24, for instance, in the userdata field of the MPEG encoded data.

For the purposes of this invention, it should be understood that no limitations exist on the type of E-data that may be generated and used. It is recognized however that high frequency image (HFI) data, which provides important edge and textual details, are important in generating an HD image. Unfortunately, encoding those regions bit by bit will significantly increase the total bitrate, which must be kept to around 5 Mbps if, e.g., a two hour video is to be stored on 4.7 Gbyte DVD. As an alternative, the present exemplary embodiment proposes to create an HD “feel” by using a multilevel sharpness enhancement on those regions.

To achieve this, a multigrid coding system within feature processing system 22 may be applied to identify and code energy significant regions using quadtree decomposition. A resulting region classification bitstream (i.e., an energy region map) will then form the E-data, which can be used to generate a gradual gain map by the decoder / playback system. In accordance with the coding system, more important areas of an image are identified and are broken into smaller and smaller blocks or regions. The partition process follows the quadtree structure and produces a string of 1's and 0's. A multilevel region classification algorithm for generating an energy region map may be implemented as follows:

1. Partition the HFI into 16×16 blocks. Then calculate the total energy (E, for the textual test) in each block and the difference (D, for the edge tests) between the average of the first three maximum pixel values and the average of the first three minimum pixel values in each block.

2. Apply the quadtree decomposition with 128×128 blocks in the HFI first. If E>threshold₁ or D>threshold₂ in any 16×16 blocks within a 128×128 block, the 128×128 block is marked as bit “1” and is then divided into 4 64×64 blocks; otherwise, the block is marked “0” without any further partition. The decomposition continues until 16×16 blocks are reached.

3. Test all 16×16 blocks with the thresholds and mark blocks “1” if E or D is greater than the thresholds plus a constant to further classify 16×16 blocks; otherwise, mark them “0”. Store all the “0”s and “1”s of the decomposition and this 16×16 block test as E-data. Depending on how dense the energy spreads are in the HFI, there may exist different bit sizes in E-data. For example, a typical 720×1280 HFI can be classified into 5 levels using less than 1000 bits. This is around 30 Kbps or 0.03 Mbps, which is very little compared with 5 Mbps of the SD layer.

It should be understood that the above algorithm is just one example of a system for generating E-data, and other methods, now known or later developed are within the scope of this invention.

3. Playback System

During playback, the bitstream in the DVD can be decoded by any DVD compliant decoder in an SD format. In addition, for an HD-enabled decoder, the E-data (stored, e.g., as userdata) is retrieved, post-processed, and combined with the regular SD upconverted pictures to create an image that can be displayed on an HD-ready TV with an HD “feel.”

In accordance with the quadtree algorithm method described above, during post-processing, the quadtree is reconstructed and a gain is assigned to each of the levels to create a gradual gain map. Thus, for example, different gains are assigned to the different block sizes or partition regions according to the quadtree structure. With the different level of enhancement gain, an HD “feel” will be created if a sharpness enhancement algorithm was applied.

Specifically, the partition regions are reconstructed by decoding the quadtree bitstream in E-data. Each region is then assigned a value based largely on the size of the region. Thus, for example, 128×128 block regions are assigned 0.5; 64×64 block regions are assigned 0.7; 32×32 block regions are assigned 0.8; and 16×16 block regions are assigned either 0.9 or 1.0. The result provides a gain map that can be used by a playback system (FIG. 2) to restore HD effects on an upconverted SD picture.

Any type of enhancement method may be utilized in conjunction with the gain map reconstructed from the E-data. Exemplary methods include adaptive peaking and/or LTI (Luminance Transient Improvement).

Referring now to FIG. 2, a playback system 30 is shown for playing back image data stored on DVD 24. Playback system 30 comprises an MPEG decoder 32 for generating either a 60 i progressive or 60 i signal and a de-interlacer 34 for generating either a 30 p or 60 p signal. An upconversion and post-processing system 36 receives the 30 p or 60 p signals, as well as the E-data, to generate HD 30 p or HD 60 p signals. A frame rate doubler or interlacer system 38 then generates either a 1080 i or 720@ 60 p output.

It is understood that the systems, functions, mechanisms, methods, and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of the invention has been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

1. A recording system for recording a high definition (HD) video onto a standard definition (SD) compatible medium, comprising:
a system for scaling down the HD video to an SD video format;
a system for encoding the SD video;
a system for extracting enhancement information from the HD video; and
a system for storing the SD video and the extracted enhancement information onto the SD compatible medium.

2. The recording system of claim 1, wherein the SD compatible medium comprises a DVD.

3. The recording system of claim 1, wherein the system for encoding comprises an MPEG-2 encoder.

4. The recording system of claim 1, wherein the enhancement information comprises high frequency image data partitioned into different energy regions.

5. The recording system of claim 4, wherein enhancement information is stored in an energy region map by a feature processing system.

6. The recording system of claim 5, wherein the energy region map is coded using a quadtree decomposition algorithm.

7. The recording system of claim 1, wherein the SD video and the extracted enhancement information are stored at a combined rate of approximately 5 megabits/second.

8. The recording system of claim 1, wherein the extracted enhancement information is stored at a rate of less than 1 megabit/second.

9. The recording system of claim 1, further comprising an aspect ratio format system for formatting the SD video for widescreen, letterboxing, and scan and pan formats.

10. The recording system of claim 1, wherein the SD video can be stored in a format selected from the group consisting of: progressive and interlaced.

11. The recording system of claim 1, wherein the enhancement information is stored in an MPEG userdata field.

12. A playback system for reconstructing a high definition (HD) video image from a standard definition (SD) format recording, comprising:
a system for extracting and decoding SD data from the recording;
a system for extracting enhancement information from the recording;
a system for de-interlacing the decoded SD data; and
a system for up-scaling and post-processing the decoded SD data with the enhancement information to generate the HD video image.

13. The playback system of claim 12, wherein the enhancement information comprises information relating to high frequency image data extracted during a recording process.

14. The playback system of claim 13, wherein the enhancement information comprises an energy region map.

15. The playback system of claim 14, wherein the energy region map is coded with a quadtree decomposition algorithm.

16. The playback system of claim 14, wherein the post-processing system applies adaptive peaking with a gain map derived from the enhancement information.

17. The playback system of claim 14, wherein the post-processing system applies luminance transient improvement with a gain map derived from the enhancement information.

18. A method for recording high definition (HD) video onto a standard definition (SD) compatible medium, comprising:
scaling down the HD video to an SD video format;
encoding the SD video;
generating enhancement information from the HD video; and
storing the SD video and the enhancement information onto the SD compatible medium.

19. The method of claim 18, wherein the step of generating enhancement information includes:
extracting high frequency image data from the HD video; and
creating a energy region map based on the high frequency image data using a quadtree algorithm.

20. The method of claim 18, wherein the enhancement information is stored in an MPEG userdata field.

21. A method of reconstructing a high definition (HD) video image from a standard definition (SD) format recording, comprising:
extracting and decoding SD data from the recording;
extracting enhancement information from the recording;
de-interlacing the decoded SD data; and
up-scaling and post-processing the decoded SD data with the enhancement information to generate the HD video image.

22. The method of claim 21, wherein the enhancement information is stored in an MPEG userdata field and comprises an energy region map coded with a quadtree decomposition algorithm.

23. The method of claim 22, wherein the decoded SD data is post-processed by applying adaptive peaking with a gain map derived from the enhancement information.

24. The method of claim 22, wherein the decoded SD data is post-processed by applying luminance transient improvement with a gain map derived from the enhancement information.

25. A program product stored on a recordable medium for recording high definition (HD) video onto a standard definition (SD) DVD, comprising:
means for scaling down the HD video to an SD format video;
means for encoding the SD video;
means for generating enhancement information from the HD video, wherein the enhancement data comprises high frequency image data; and
means for storing the SD format video and the enhancement information onto the DVD.

26. A program product stored on a recordable medium for reconstructing a high definition (HD) video image from a standard definition (SD) DVD, comprising:
means for extracting and decoding SD data from the DVD;
means for extracting enhancement information from the DVD, wherein the enhancement information is stored in an MPEG userdata field and comprises high frequency image data;
means for de-interlacing the decoded SD data; and
means for up-scaling and post-processing the decoded SD data with the enhancement information to generate the HD video image.

27. The program product of claim 26, wherein the post-processing means applies one of the group consisting of: adaptive peaking and luminance transient improvement, with a gain map derived from the enhancement information.
